(19) United States
(12) Patent Application Publication
(10) Pub. No.: US 2020/0173414 A1
(43) Pub. Date: Jun. 4, 2020

(54) ENGINE START CONTROL FOR AN IDLE STOP-AND-GO VEHICLE

(71) Applicants: Hyundai Motor Company, Seoul (KR); Kia Motors Corporation, Seoul (KR)

(72) Inventors: Jason Hoon Lee, Ann Arbor, MI (US); Khoa Nguyen, Superior Township, MI (US); Sejun Kim, Superior Township, MI (US); Jaihyun Lee, Ypsilanti, MI (US); Kwangwoo Jeong, Ann Arbor, MI (US); Jerome Gregeois, Claremont, CA (US); Byungho Lee, Ann Arbor, MI (US)

(21) Appl. No.: 16/207,104

(22) Filed: Dec. 1, 2018

(51) Int. Cl. F02N 11/08

(52) U.S. Cl. CPC F02N 11/0837; F02N 11/0822; F02N 2200/125; F02N 2200/102; F02N 2200/123

(57) ABSTRACT

A method for controlling an engine start of an idle stop and go vehicle is provided. The method includes detecting an engine stop and a brake pedal engagement and in response, detecting whether a target vehicle is located in a vicinity of the vehicle. A position of the target vehicle is also detected and when the position changes, the engine of the vehicle is restarted.

### BACKGROUND

### Technical Field of the Disclosure

The present disclosure relates to a method and system for controlling engine start of an idle stop-and-go (ISG) vehicle, and more particularly, to a method and system for controlling engine start of an ISG vehicle based on position and speed of a preceding vehicle.

### Description of the Related Art

Today, engine idle stop and go (ISG) systems are used to improve fuel consumption by stopping or disabling the engine based on current vehicle speed. For example, an ISG system automatically turns off the vehicle engine when the vehicle speed is decreased to zero and the brake pedal is engaged. Once the brake pedal is disengaged, the engine is typically automatically restarted. This stopping and restarting of the engine is based on current being supplied to electrical loads within the vehicle by an alternator or an integrated starter generator.

However, often in using such ISG systems, drivers experience hesitation in the engine restart once the brake pedal is disengaged. For example, a hesitation sensation may be experienced by a driver when there is a delay in restarting the engine. Thus, systems have been developed that aim to restart the engine prior to the brake pedal being disengaged. These systems automatically restart the engine in response to detecting a vehicle is in a turn lane based on traffic data. However, the automatic restart is limited to the vehicle being located in such a turn lane. These systems are unable to consider other driving situations such as traffic congestion (e.g., stop and go traffic). Due to the limitation of such ISG systems causing user inconvenience, drivers may tend to deactivate the system. By deactivating ISG system, the purpose of improving fuel consumption is unable to be achieved.

The above information disclosed in this section is merely for enhancement of understanding of the background of the disclosure and therefore it may contain information that does not form the prior art that is already known in this country to a person of ordinary skill in the art.

### SUMMARY

The present disclosure provides a method and system that control an engine start of an engine in an idle stop and go (ISG) vehicle. The method and system are capable of restarting an engine within the vehicle prior to release of a brake pedal by detecting position and velocity of a preceding vehicle.

According to one aspect of the present disclosure, a method of controlling engine start of an ISG vehicle may include detecting an engine stop and a brake pedal engagement. In response to detecting the engine stop and the brake pedal engagement, whether a target vehicle is located in a vicinity of the vehicle may be detected. Additionally, a position of the target vehicle may be detected and when the position of the target vehicle changes, the engine may be restarted. In particular, the engine may be restarted when the target vehicle is detected to have moved a predetermined distance from the detected position. The target vehicle may be initially detected by continuously monitoring the vicinity of the vehicle using a camera mounted on the vehicle and whether the position of the target vehicle is within a predetermined threshold distance from the vehicle may be determined.

Further, the method may include detecting a velocity of the target vehicle and the engine may be restarted when the velocity of the target vehicle is greater than a threshold velocity. The target vehicle may be specifically located ahead of the vehicle. The position of the target vehicle may be detected by measuring a distance from the vehicle to the target vehicle and the engine may be restarted when a distance from the vehicle to the target vehicle increases from an initially detected distance. In particular, the position and velocity of the target vehicle may be detected using a plurality of sensors installed within the vehicle. The engine stop may be detected based on detecting a vehicle speed as zero.

According to another aspect of the present disclosure, a method of controlling engine start of an ISG vehicle may include detecting an engine stop and a brake pedal engagement. In response to detecting the engine stop and the brake pedal engagement, whether a target vehicle is located in a vicinity of the vehicle may be determined. A position and a velocity of the target vehicle may then be determined. The engine of the vehicle may be restarted when a current position of the target vehicle is greater than a threshold distance from the detected position or the velocity of the target vehicle is greater than a threshold velocity.

According to yet another aspect of the present disclosure, an ISG vehicle may include an engine and an ISG controller configured to detect an engine stop and restart the engine based on detecting whether a target vehicle is within a predetermined distance from the vehicle and whether a velocity of the target vehicle is greater than a threshold velocity. The ISG controller may be mounted within an engine controller and may be configured to detect the engine stop when the current speed of the vehicle is zero and the brake pedal is engaged.

Additionally, in response to determining that the velocity of the target vehicle is less than the threshold velocity, the IS G controller may be configured to determine whether a current position of the target vehicle is greater than a threshold distance from an initially detected position. The ISG controller may be configured to restart the engine when the current position of the target vehicle is greater than the threshold distance from the initially detected position.

Further, the ISG controller may be configured to transmit signals to an auto engine restart controller configured to restart the engine when the current position of the target vehicle is greater than the threshold distance from the initially detected position. The vehicle may further include a speed sensor configured to detect a current speed of the vehicle and a brake pedal position sensor configured to detect engagement of a brake pedal of the vehicle. Additionally, the vehicle may include a sensor configured to detect the position and velocity of the target vehicle. The sensor may include a camera and a radar. The position of the target vehicle may also be obtained from a surrounding vehicle via V2V communication.

Notably, the present disclosure is not limited to the combination of the elements as listed above and may be assembled in any combination of the elements as described herein.

Other aspects of the disclosure are disclosed infra.

### BRIEF DESCRIPTION OF THE DRAWINGS

The above and other objects, features and advantages of the present disclosure will be more apparent from the following detailed description taken in conjunction with the accompanying drawings.

FIG. 1 illustrates a system within an idle stop and go vehicle according to an exemplary embodiment of the present disclosure; and

FIG. 2 illustrates a method of controlling engine start of an idle stop and go vehicle according to an exemplary embodiment of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present disclosure provides a method and system for controlling an engine start of an idle start and go (ISG) vehicle (e.g., an auto start-stop vehicle) in response to detecting a position change or increased velocity of a preceding vehicle (e.g., a target vehicle). Thus, the present disclosure is capable of restarting the engine in response to a detected event without requiring user manipulation of a brake pedal or other user input. Accordingly, the engine may already be running when a driver is ready to drive the vehicle when, for example, traffic flow begins to change, a traffic signal changes, or other similar types of situations. Additionally, by restarting the engine prior to user input, fuel consumption may still be decreased as advantageously provided by ISG systems which avoid the engine from stopping and being restarted in areas where the stop duration is short.

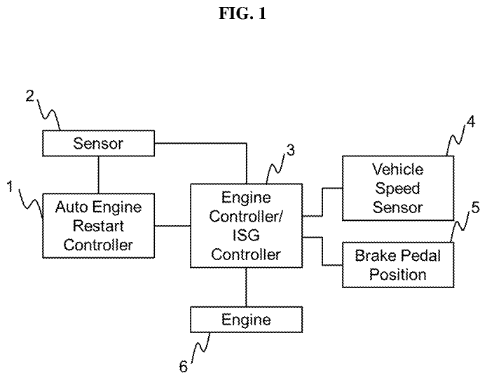

According to an aspect of the present disclosure and as shown in FIG. 1, an ISG vehicle may include an engine 6, an engine controller 3, a vehicle speed sensor 4, a brake pedal position sensor 5, an auto engine restart controller 1, and another sensor 2. In particular, the engine controller 3 may include an ISG controller mounted therein configured to detect an engine stop and a brake pedal engagement. The brake pedal engagement may be detected by the brake pedal position sensor and the engine stop may be determined based on the vehicle speed sensor 4 detecting the vehicle speed as zero.

Particularly, the auto engine restart controller 1 may be configured to transmit a signal to the ISG controller to restart the engine 6. That is, the auto engine restart controller 1 may be configured to send an auto engine restart logic signal to the ISG controller within the engine controller 3 to restart the engine. The engine 6 may be restarted based on detecting whether a target vehicle is within a predetermined distance from the vehicle (e.g., subject vehicle) and whether a velocity of the target vehicle is greater than a threshold velocity. The sensor 2 may be configured to detect a target vehicle within the vicinity of the subject vehicle. For example, the sensor 2 may include a camera or a radar typically provided within an ADAS system. To detect the target vehicle, the sensor 2 may be configured to detect a distance between the host or subject vehicle and the target vehicle as well as the velocity of the target vehicle. For example, the sensor 2 may be configured to determine whether the target vehicle stops in the same driving lane in front of the subject vehicle.

When the target vehicle is within a predetermined distance from the vehicle and the velocity of the target vehicle is greater than the threshold velocity (e.g., equal to or greater than about 0.6 m/s), the engine 6 may be restarted. However, when the target vehicle is within the predetermined distance from the vehicle but the velocity of the target vehicle is less than the threshold velocity, the ISG controller may be configured to determine whether a current position of the target vehicle is greater than a threshold distance (e.g., equal to or greater than about 3 m) from an initially detected position. That is, the ISG controller may be configured to determine whether the target vehicle has moved a predetermined distance away from the subject vehicle. If the current position of the target vehicle is greater than the threshold distance from the initially detected position, the engine may also be restarted. However, if the current position is less than the threshold distance from the initially detected position, an ISG mode may be maintained. In other words, the ISG mode as previously described may be maintained without interruption based on intervening conditions. Similarly, if the target vehicle is not within a predetermined distance from the vehicle, the ISG mode may be maintained without interruption.

According to an exemplary embodiment of the present disclosure, the ISG vehicle may communicate with other surrounding vehicles using V2V communication or may communicate with a central server or communications-enabled traffic signals using V2I communications. The position of the target vehicle may be detected using V2V communication or V2I communication. For example, the subject vehicle may receive traffic information from surrounding vehicles or other servers to thus determine a position of a vehicle located in front of the subject vehicle. The V2V communication may also provide the vehicle with speed information of the target vehicle or other vehicles in the vicinity of the subject vehicle. Additionally, the V2I communication may provide the subject vehicle with traffic light status information. For example, the ISG vehicle may be configured to receive a signal from a traffic signal device indicating that the traffic signal or light is about to change. Accordingly, the engine may be restarted prior to the signal change allows for a more rapid launch of the vehicle when the signal does change.

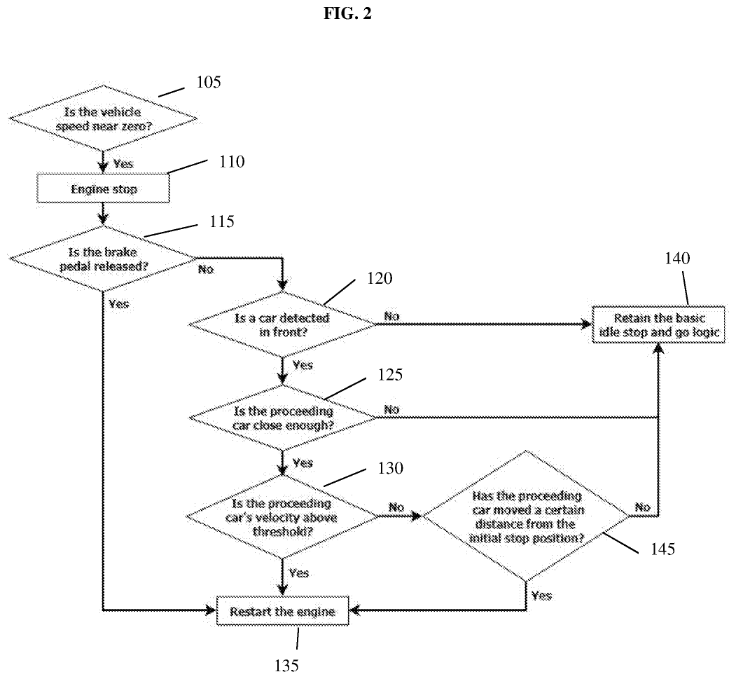

Moreover, according to another aspect of the present disclosure, a method of controlling engine start of an idle stop and go (ISG) vehicle may be provided. Referring to FIG. 2 the method described herein below may be executed by a controller having a processor and a memory and the controller may be mounted within the ISG vehicle.

Particularly, the method may include detecting an engine stop (110) and a brake pedal engagement (115) of the vehicle. For example, the brake pedal engagement may include determining whether the brake pedal has been released. The engine stop may be detected based on detecting a vehicle speed as zero (105). If the brake pedal is determined to have been released, the engine may be restarted (135). However, if the brake pedal has not been released, the method may include detecting whether a target vehicle in a vicinity of the vehicle (120) in response to detecting the engine stop and the brake pedal engagement. That is, the method may include determining whether a vehicle is located in front of the subject vehicle in the same driving lane. The target vehicle may be detected by continuously monitoring the vicinity of the vehicle. For example, the vicinity of the vehicle may be monitored using an imaging device (e.g., camera, video camera, or the like) mounted on the vehicle.

If a target vehicle is not detected, the ISG mode may be maintained (140). In other words, no interruptions to the ISG mode may be considered and the ISG mode may be maintained in a normal state. The target vehicle may specifically be detected to be located ahead of the subject vehicle. Further, in response to detecting the target vehicle, the method may include detecting a position of the target vehicle. The engine may then be restarted when the position of the target vehicle changes. That is, the engine may be restarted when the target vehicle is detected to have moved a predetermined distance from the detected position.

In one exemplary embodiment, prior to determining whether the position of the target vehicle has changed, the method may include determining whether the target vehicle (e.g. preceding vehicle) is close enough to the subject vehicle by determining whether the position of the target vehicle is within a predetermined threshold distance from the subject vehicle (125). If the target vehicle is not within that predetermined threshold distance (e.g., is further away from the subject vehicle), the ISG mode may be maintained without interruption or alteration. However, if the target vehicle is within the predetermined threshold distance, the method may include detecting a velocity of the target vehicle. The velocity of the target vehicle may be compared with a threshold velocity (130) and when the velocity is greater than the threshold velocity, the engine may be restarted (135). For example, the threshold velocity may be between about 0.4 m/s and 1 m/s.

However, when the velocity of the target vehicle is less than the threshold velocity, the method may include determining whether a current position of the target vehicle is greater than a threshold distance from the detected position (145). If the current position is less the threshold distance, the IS G mode may be maintained without interruptions or alterations. When the current position is greater than the threshold distance, the engine may be restarted (135). The position of target vehicle may be specifically detected by measuring a distance from the subject vehicle to the target vehicle. The engine may thus be restarted when a distance from the vehicle to the target vehicle increases by a predetermined distance from an initially detected distance. Accordingly, the method may restart the engine prior to a driver releasing a brake pedal by anticipating, for example, that traffic will begin to move. The anticipation of surrounding traffic movement may be determined based on the distance to a preceding vehicle and the velocity of such a preceding vehicle. Thus, by detecting that a preceding vehicle begins to move, the engine may be advantageously started ahead of the driver releasing the brake pedal. This decreases any potential delay that a driver may experience in restarting the engine and launches the vehicle more rapidly.

According to another exemplary embodiment of the present disclosure, a method of controlling engine stop of an ISG vehicle may include detecting an engine stop and a brake pedal engagement of the vehicle using a speed sensor and a brake pedal position sensor and then detecting whether a target vehicle is located in a vicinity of the vehicle. A position and a velocity of the target vehicle may be detected using a plurality of sensors (e.g., a camera, radar, or the like). The engine of the vehicle may then be restarted when a current position of the target vehicle is greater than a threshold distance from the detected position or the velocity of the target vehicle is greater than a threshold velocity.

The method and system disclosed herein are capable of obtaining information regarding the surrounding vehicles using sensors already mounted within a vehicle. For example, such sensors are typically installed in an advanced driver assistance system (ADAS) module, thus preventing any increase in costs due to adding additional components to the vehicle. Additionally, the present disclosure is capable of improving response of motor vehicle drive by automatically restarting an engine in an ISG vehicle without user input. Further, the present disclosure is capable of restarting the engine in the ISG vehicle by receiving a signal related to a future change of a traffic signal. Accordingly, the engine may already be running when a driver is ready to drive the vehicle based on, for example, a traffic signal change or a flow of traffic.

Hereinabove, although the present disclosure is described by specific matters such as concrete components, and the like, the exemplary embodiments, and drawings, they are provided merely for assisting in the entire understanding of the present disclosure. Therefore, the present disclosure is not limited to the exemplary embodiment. Various modifications and changes may be made by those skilled in the art to which the disclosure pertains from this description. Therefore, the spirit of the present disclosure should not be limited to the above-described exemplary embodiments, and the following claims as well as all technical spirits modified equally or equivalently to the claims should be interpreted to fall within the scope and spirit of the disclosure.

What is claimed is:

1. A method of controlling engine start of an idle stop and go vehicle, comprising:
detecting an engine stop and a brake pedal engagement of the vehicle;
detecting whether a target vehicle is located in a vicinity of the vehicle in response to detecting the engine stop and the brake pedal engagement;
detecting a position of the target vehicle; and
restarting the engine when the position of the target vehicle changes.

2. The method of claim 1, further comprising:
restarting the engine when the target vehicle is detected to have moved a predetermined distance from the detected position.

3. The method of claim 1, further comprising:
detecting a velocity of the target vehicle; and
restarting the engine when the velocity of the target vehicle is greater than a threshold velocity.

4. The method of claim 1, further comprising:
determining whether the position of the target vehicle is within a predetermined threshold distance from the vehicle.

5. The method of claim 1, wherein the target vehicle is located ahead of the vehicle.

6. The method of claim 1, wherein the position of the target vehicle is detected by measuring a distance from the vehicle to the target vehicle and the engine is restarted when a distance from the vehicle to the target vehicle increases from an initially detected distance.

7. The method of claim 1, wherein the engine stop is detected based on detecting a vehicle speed as zero.

8. The method of claim 1, wherein the target vehicle is detected by continuously monitoring the vicinity of the vehicle.

9. The method of claim 8, wherein the vicinity of the vehicle is monitored using a camera mounted on the vehicle.

10. The method of claim 1, wherein the position and velocity of the target vehicle are detected using a plurality of sensors installed within the vehicle.

11. A method of controlling engine start of an idle stop and go (ISG) vehicle, comprising:
detecting an engine stop and a brake pedal engagement of the vehicle;
detecting whether a target vehicle is located in a vicinity of the vehicle in response to detecting the engine stop and the brake pedal engagement;
detecting a position of the target vehicle;
detecting a velocity of the target vehicle; and
restarting the engine when a current position of the target vehicle is greater than a threshold distance from the detected position or the velocity of the target vehicle is greater than a threshold velocity.

12. The method of claim 1, wherein the target vehicle is located ahead of the vehicle.

13. The method of claim 11, wherein the engine stop is detected based on detecting a vehicle speed as zero.

14. The method of claim 11, wherein the target vehicle is detected by continuously monitoring the vicinity of the vehicle.

15. The method of claim 11, wherein the vicinity of the vehicle is a predetermined threshold distance from the vehicle.

16. An idle stop and go vehicle, comprising:
an engine; and
an idle stop and go (ISG) controller configured to detect an engine stop and brake pedal engagement of the vehicle and restart the engine based on detecting whether a target vehicle is within a predetermined distance from the vehicle and whether a velocity of the target vehicle is greater than a threshold velocity.

17. The vehicle of claim 16, wherein in response to determining that the velocity of the target vehicle is less than the threshold velocity, the ISG controller is configured to determine whether a current position of the target vehicle is greater than a threshold distance from an initially detected position.

18. The vehicle of claim 17, wherein the ISG controller is configured to restart the engine when the current position of the target vehicle is greater than the threshold distance from the initially detected position.

19. The vehicle of claim 16, wherein the ISG controller is mounted within an engine controller.

20. The vehicle of claim 16, wherein the ISG controller is configured to transmit signals to an auto engine restart controller configured to restart the engine when the current position of the target vehicle is greater than the threshold distance from the initially detected position.

21. The vehicle of claim 20, further comprising:
a speed sensor configured to detect a current speed of the vehicle; and
a brake pedal position sensor configured to detect the engagement of the brake pedal of the vehicle.

22. The vehicle of claim 21, wherein the ISG controller is configured to detect the engine stop when the current speed of the vehicle is zero and the brake pedal is engaged.

23. The vehicle of claim 16, further comprising:
a sensor configured to detect the position and velocity of the target vehicle.

24. The vehicle of claim 23, wherein the sensor includes a camera and a radar configured to detect the position and velocity of the target vehicle.

25. The vehicle of claim 16, wherein the position of the target vehicle is obtained from a surrounding vehicle via V2V communication.
